(19) United States
(12) Patent Application Publication
(10) Pub. No.: US 2023/0092153 A1
(43) Pub. Date: Mar. 23, 2023

(54) COMBINED OIL COOLING CONCEPT FOR AN ELECTRIC MACHINE WITH A ROTOR-INTEGRATED CLUTCH, ELECTRIC MACHINE, DRIVE TRAIN AND METHOD FOR COOLING AN ELECTRIC MACHINE

(71) Applicant: Schaeffler Technologies AG & Co. KG, Herzogenaurach (DE)

(72) Inventors: Christian Steinwandel, Bühlertal (DE); Robert Maier, Gernsbach (DE); Wolfgang Hill, Karlsruhe (DE); Sascha Peter, Bühl (DE)

(73) Assignee: Schaeffler Technologies AG & Co. KG, Herzogenaurach (DE)

(21) Appl. No.: 17/911,479

(22) PCT Filed: Mar. 5, 2021
(86) PCT No.: PCT/DE2021/100223

§ 371 Date: Sep. 14, 2022

(30) Foreign Application Priority Data
Mar. 16, 2020 (DE) 10 2020 107 116.7

(51) Int. Cl. H02K 9/19; H02K 7/00; H02K 7/108

(52) U.S. Cl. CPC H02K 9/19; H02K 7/006; H02K 7/108

(57) ABSTRACT

An electric machine includes a rotor-integrated clutch for a drive train of a motor vehicle, and has a stator and a rotor. The rotor has a carrier, on which a first part of a friction clutch configured for a force-locking connection with a second part is attached, wherein a coolant fluid line is provided in order to supply the stator or the rotor with coolant fluid to bring about heat dissipation. The coolant fluid line is arranged and perforated such that the coolant fluid both drips under gravity onto a section of the rotor in order to generate a spray mist, and flows over the outer surface of the stator.

### CROSS-REFERENCE TO RELATED APPLICATIONS

This application is the U.S. National Phase of PCT Appln. No. PCT/DE2021/100223 filed Mar. 5, 2021, which claims priority to DE 10 2020 107 116.7 filed Mar. 16, 2020, the entire disclosures of which are incorporated by reference herein.

### TECHNICAL FIELD

The disclosure relates to an electric machine having a rotor-integrated clutch for a drive train of a motor vehicle, such as a (P2) hybrid vehicle, with a stator and a rotor (electrically) associated with it, wherein the rotor has a carrier to which a first part of a friction clutch prepared for a frictional connection with a second part is attached/fastened (at least in a rotationally fixed manner), wherein a coolant fluid line is provided or multiple coolant lines is provided in order to supply coolant fluid, such as oil, to the stator and/or the rotor for causing heat dissipation.

### BACKGROUND

Electric machines with a rotor-integrated clutch and coolant fluid line for cooling the stator and/or the rotor are already known from the prior art.

The documents WO 2012/061439 A2, JP 2009-136070 A, DE 11 2011 102 609 T5 and DE 11 2016 002 202 T5 are also known from the prior art.

WO 2012/061439 A2 discloses an electric machine in the manner of an electric motor and a method for cooling. The Japanese publication also discloses an electric machine with a cooling concept.

DE 11 2011 102 609 T5 presents a stator cooling device, in particular disclosed as a stator cooling device having a cylindrical stator main body using a rotational axis of a rotating electric machine as a central axis, a fixing region formed on an outer peripheral region of the stator main body, to project outward in a radial direction of the stator main body, and which fixes the stator main body to a housing accommodating the rotating electric machine and to a coolant flow channel into which a coolant is supplied and which includes an injection hole through which the coolant is introduced, wherein the fixing region is arranged across a horizontal plane passing through the central axis, and a vertex region which, when viewed in an axial direction of the central axis, is arranged in the fixing region farthest away from the central axis at a position displaced from a first vertical plane which is a vertical plane passing through the central axis, and the injection hole is open toward the fixing region above the outer peripheral region of the stator main body and toward the side of the first vertical plane with respect to a second vertical plane, which is a vertical plane, passing through the apex region.

DE 11 2016/002 202 T5 discloses a rotary electric machine which suppresses the inflow of a coolant into a magnetic air gap region to suppress generation of frictional heat and which increases the cooling capability for cooling a permanent magnet by using a construction in which a coolant comes into contact with permanent magnets. Coolant flow channels there have the following: a main flow channel formed so as to be spaced from the magnet receiving opening on an inner peripheral side and forming a tubular flow channel extending axially through the rotor core; a magnet cooling flow channel formed along the permanent magnet received in the magnet receiving opening on an inner peripheral side of the permanent magnet, wherein the magnet cooling flow channel extends axially through the rotor core, and wherein an inner peripheral surface of the permanent magnet forms a part of the magnet cooling flow channel; and a transfer flow channel extending axially through the rotor core to connect the main flow channel and the magnet cooling flow channel, wherein a first end plate opens a first axial end of the main flow channel and closes a first axial end of the magnet cooling flow channel and the transfer flow channel, wherein a second end plate opens second axial ends of the main flow channel, the magnet cooling flow channel, and the transfer flow channel; and wherein the coolant supplied to the magnetic cooling flow channel from the first axial end flows into the magnetic cooling flow channel through the bypass flow channel and comes into contact with the permanent magnets while flowing through the magnetic cooling flow channel.

DE 10 2013 215 790 A1 discloses an arrangement in which oil from a rotor-integrated clutch appears to be used to cool the electric motor. A drive arrangement for a motor vehicle having an electric machine and a clutch arrangement is disclosed there, wherein the electric machine is arranged radially outside the clutch arrangement and has a rotor which is preferably connected in a rotationally fixed manner to the clutch arrangement, wherein a coolant conducting element is also provided which at least partially essentially extends radially and is arranged axially next to the clutch arrangement in such a way that a coolant can be guided axially at least partially outside the clutch arrangement from radially inside to radially outside of the rotor.

However, the solutions known from the prior art always have disadvantages.

These disadvantages should be eliminated or at least reduced.

### SUMMARY

In the case of an electric machine of this type, this object is achieved according to the disclosure in that the one or more lines is/are arranged and provided with one or more openings/is/are perforated in such a way that coolant fluid predominantly/only in a gravity-driven manner drips both onto a section, preferably on the support of the rotor, in order thereby to produce a spray mist and to flow over the outer surface of the stator. Such gravity-driven flow and/or dripping is pressure-independent. The opening characteristics in the duct are different from nozzles. The corresponding openings have a constant cross section over their length.

It is therefore significant that the line is arranged radially outside and in the direction of gravity above the axis of rotation of the electric machine and/or the outer surface of the stator located at the top as seen in the direction of gravity.

Advantageous embodiments are claimed and are explained below.

It is advantageous if the fluid line is arranged above and radially outside of the stator, viewed in the direction of gravity. Without having to count on the power of a pump, primary cooling and secondary cooling can then be achieved evenly; for example, even if power of one pump fails.

A particularly good cooling effect can be achieved if the cooling fluid line has at least one through-hole arranged (approximately/exactly) centrally and in the direction of gravity above (i.e., at least above the highest tenth) of a winding/coil attached to the stator, as seen in the longitudinal direction of the stator, in order to generate a secondary fluid flow and/or the coolant fluid line has at least one fluid outlet above the rotor, as seen in the direction of gravity, in order to generate a primary coolant fluid flow. It means that oil is sprayed onto the rotor carrier, which is firmly connected to rotor and oil is thrown off again. The combination of a primary coolant fluid flow and a secondary coolant fluid flow leads to high cooling efficiency.

Such a high level of efficiency can then be achieved with inexpensive means if there is (at least/exactly) one fluid outlet hole on each end face of the rotor.

In order to avoid excessive misting, it is advantageous if the fluid outlet hole, which is non-nozzle-like, is dimensioned and arranged, for example in the manner of a bore, for essentially gravity-driven wetting/dripping of winding heads. A supply of the coolant fluid to the rotor/stator under the exclusive or predominant effect of gravity can then be cleverly implemented. In the case of the fluid outlet hole, which is non-nozzle-like, it is particularly important that the pressure loss is low, i.e., less pump power is required.

It has also proven useful if at least two through holes are arranged on both sides of the longitudinal axis of the coolant fluid line and preferably multiple such through holes arranged in pairs are distributed over the length of the coolant fluid line. A particularly rapid cooling effect then sets in.

In order to achieve an optimized cooling effect for both the rotor and the stator, it is advantageous if the through holes and fluid outlet holes have the same cross section or if the through holes are at least 10% to 3% larger or 10% to 2% smaller than the fluid outlet holes.

In order to facilitate the connection to a clutch cooling system, for example, it is advantageous if the coolant fluid line is connected to a supply line. It should be added here that the supply line is normally connected to the cooling oil inflow of the transmission.

The disclosure ultimately also relates to a drive train of a motor vehicle with an electric machine of the type according to the disclosure.

The disclosure further relates to a method for cooling an electric machine of the type according to the disclosure, wherein oil from a coolant fluid line is both dripped under gravity onto a rotor and flows under gravity onto a stator winding.

A cooling concept for an electric machine/an electric motor with a rotor-integrated clutch is thus presented. Such a concept results in cost savings. The reliability of such a cooling concept is also higher than previously known in the prior art. Two cooling concepts are combined in such a way that they complement one another in a meaningful way. A permanently used primary cooling concept as well as a secondary cooling concept used therein is also implemented in a particularly cost-effective manner. Disadvantages of the previous cooling concepts, as they are known, are now eliminated. Spray oil is used in the primary cooling concept. Oil is dripped onto rotating elements, which spray off oil as they rotate if the rotational speed is high enough to mist the winding heads. The oil used for cooling wets the end windings and dissipates the heat generated there.

The secondary cooling concept relies on jacket cooling, wherein two streams of cooling oil are directed from above the stator onto a stator jacket, so that oil flows down both sides of a cylinder. Due to the relatively high surface adhesion of the oil, the oil even flows onto the underside of the stator jacket. The flowing oil on the outside of the stator transports away the heat generated there.

The disadvantages that only a very small oil volume flow was previously provided via a rotor-integrated clutch in order to keep the drag torque low are now eliminated. Provision of a primary cooling oil volume flow above an electric motor through selective provision is optimized.

The inventive concept also has a rotor-integrated clutch, the oil flow of which is also used to cool the electric motor. Due to the combination with the oil supply from the outside, however, it is possible to vary the oil flows as required. The drag losses can thus be reduced.

Many electric machine topologies are now possible, wherein the heat transfer between the individual stator teeth/stator head/winding head is no longer so limited, since the oil provided is cleverly distributed. All, or as far as possible all, of the stator teeth come into contact with the oil evenly. Ultimately, a cost-effective solution is then found as to how an electric machine with selective cooling oil supply can be cooled as evenly as possible. The drag losses are kept as low as possible, which occur when rotating components splash through/in oil. Nozzles are avoided, which means that back pressure is not increased, which now also no longer requires an increased pumping capacity. This reduces costs and avoids power losses. A cooling jacket is now also designed in a particularly cost-effective manner. Seals and complex processing steps are avoided.

Ultimately, two very simple cooling concepts are combined very expediently, wherein the individual disadvantages, as they were known, are balanced out. The individual cooling concepts are now implemented very cost-effectively. Weaknesses are compensated by their combination. In other words, a primary cooling concept based on spray oil cooling is presented. In this process, oil is dripped onto rotating elements, which in turn throw the oil off at sufficient speed and thus transport it to the end windings. There, the oil wets the winding heads and thus effectively dissipates the heat generated there. No nozzle is used to provide the oil, just a hole from which the oil drips, since the actual distribution of the oil occurs when it is thrown off the rotating parts. This saves costs for the nozzle and a cheaper pump can be used.

Since this concept only becomes effective at a certain minimum speed, a second cooling path is used. This second cooling path implements a secondary cooling concept in the manner of jacket cooling. Two streams of cooling oil are directed onto the stator jacket from above, e.g., from the 12 o'clock position, so that it is covered by a stream of oil on both sides of the cylinder. Due to the comparatively high surface tension of oil, the oil flow also runs on the underside of the stator jacket. The oil flowing past the outside of the stator also transports heat away. No dedicated cooling channel is used in order to keep manufacturing costs low. Oil that does not run along the circumference of the stator jacket, but is “lost” axially, in turn contributes to the spray oil cooling mentioned above.

Cooling oil for electric machine cooling is provided at or near the 12 o'clock position of the electric machine; for example, via a tube or bore in the housing that flows around the electric machine. This ensures a supply line or multiple supply lines. In this line there are holes in at least three, four, five or six positions, namely on the two end faces of the electric machine and centrally above the stator jacket, wherein two holes are preferred there. The distribution of the cooling oil flows can be defined by selecting the size of the hole.

With regard to spray cooling, it should be added that the holes are positioned on the end faces of the electric machine in such a way that the escaping oil drips through holes in the stator carrier, which are distributed over the upper region of the circumference. The oil that drips down the end faces of the electric machine then hits rotating components, such as the rotor carrier, which in turn throws the oil off radially, causing the oil to be sprayed onto the end windings of the stator, where it cools them down. In addition, the rotating components, e.g., the electric machine rotor and the rotor-integrated clutch, are cooled because the cooling oil is first routed along this component. Since this type of cooling only works above a certain speed, it makes sense to connect it to another cooling path.

Jacket cooling is used for this purpose. The two holes that are usually located centrally above the stator jacket are introduced into the supply line in such a way that the two resulting oil flows do not hit the stator jacket exactly at its highest point, but are slightly offset on both sides, so that the cooling oil flow occurs along the stator jacket on both sides. These are so-called jacket currents. There is also the possibility of using a plurality of holes, i.e., more than two holes in a targeted manner.

Since the holes are located centrally above the stator in the axial direction, a large part runs along its outside and only a small proportion runs down the free end face. Due to surface tension, the oil flow adheres to the stator jacket even far below the 3 o'clock or 9 o'clock position, which also cools the lower half of the electric machine. Only near the 6 o'clock position does the flow break away from the stator jacket. However, this region is well cooled by the spray oil cooling, since due to gravity and the position of the oil drain in the lower area of the electric machine, the entire oil volume flow ultimately flows around these areas. The jacket cooling is speed-independent and can therefore provide a certain basic cooling even at the lowest speeds, which compensates for the weak point of the spray cooling. Since the oil used for jacket cooling does not come into contact with rotating parts, this also reduces the drag losses that would occur with pure spray oil cooling. The combination of the two concepts also increases the robustness of the overall cooling with regard to the different oil inlet temperatures that occur during operation. For example, the effectiveness ofjacket cooling is reduced when oil inlet temperatures rise because viscosity and surface tension decrease, causing the oil flow to break away from the stator jacket earlier. At the same time, the two influencing factors ensure that the oil is better distributed by the spray cooling and works even at a lower speed. This is partly due to a smaller droplet size.

The combination of the two cooling concepts can also improve the efficiency of the cooling. Here, simulations show that with the same total volume flow, the maximum component temperatures that occur are significantly lower than if only one of the two cooling concepts were used. The pump capacity of the coolant pump can thus be reduced, which in turn contributes to the efficiency of the overall system.

### BRIEF DESCRIPTION OF THE DRAWINGS

The disclosure is further explained below with the aid of drawings. A first embodiment is shown, which is described below.

FIG. 1 shows a partially represented longitudinal section through an electric machine according to the disclosure, and

FIG. 2 shows a partially represented cross section along the line II from FIG. 1.

### DETAILED DESCRIPTION

The figures are only schematic in nature and serve only for comprehension of the disclosure. The same elements are provided with the same reference signs.

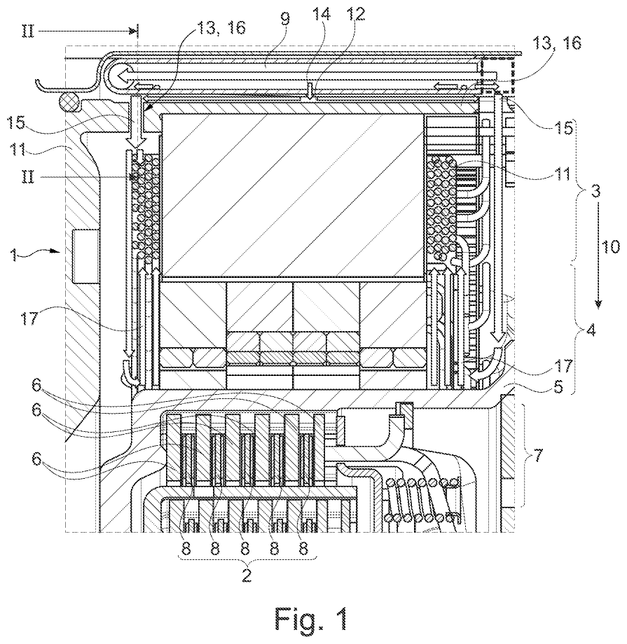

FIG. 1 shows an electric machine according to the disclosure. It has a rotor-integrated clutch 2. The electric machine has both a stator 3 and a rotor 4 arranged radially inside of it. The rotor 4 has a carrier 5. The carrier 5 holds a first part 6 of a friction clutch 7. A second part 8 is prepared for frictional engagement with the first part 6. The first part 6 is made up of pressure plates and friction plates. The second part 8 also has friction plates, namely carrier discs with friction linings on both sides.

There is a coolant fluid line 9 which acts as a supply line. The coolant fluid line 9 is arranged radially outside and viewed in the direction of gravity 10 above the stator and a stator winding 11.

The coolant fluid line 9 has two through holes 12. Furthermore, two fluid outlet holes 13 are provided.

The oil that emerges from the through holes 12 realizes a secondary coolant fluid flow 14. A primary coolant fluid flow occurs at two fluid outlets 16 realized by the fluid outlet holes 13.

The oil that meets the carrier 5 is then thrown off again and creates a spray mist 17.

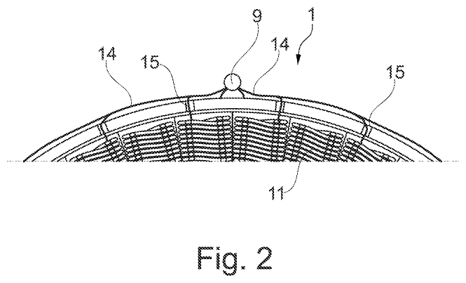

FIG. 2 shows the outlet of oil and the reaching of the secondary coolant fluid flow 14 and the primary coolant fluid flow 15.

A total oil volume flow of approx. 3, 4, 5, 6, 7, 8, 9 or 10 liters per minute is aimed for, which is divided into a fluid flow along the stator jacket on the one hand and a spray oil portion on the other. A split of 1:3 or 1:4 or 1:5 to 5:1 or 4:1 or 3:1 is considered.

### LIST OF REFERENCE SYMBOLS

1 Electric machine

2 Rotor-integrated clutch

3 Stator

4 Rotor

5 Carrier

6 First part

7 Friction clutch

8 Second part

9 Coolant fluid line

10 Direction of gravity

11 Stator winding

12 Through hole

13 Fluid outlet hole

14 Secondary coolant fluid flow

15 Primary coolant fluid flow

16 Fluid outlet

17 Spray mist

1. An electric machine having a rotor-integrated clutch for a drive train of a motor vehicle, the electric machine comprising a stator and a rotor wherein the rotor has a carrier, on which a first part of a friction clutch configured for a force-locking connection with a second part is attached, wherein a coolant fluid line is provided in order to supply the stator or the rotor with coolant fluid to bring about heat dissipation, wherein the coolant fluid line is arranged and perforated such that the coolant fluid both drips under gravity onto a section of the rotor in order to generate a spray mist, and flows over an outer surface of the stator.

2. The electric machine according to claim 1, wherein the coolant fluid line, seen in a direction of gravity, is arranged above and radially outside the stator.

3. The electric machine according to claim 1, wherein the coolant fluid line has at least one through hole arranged centrally, as seen in the a longitudinal direction of the stator, and in a direction of gravity above a winding fitted to the stator, in order to generate a secondary coolant fluid flow or that the coolant fluid line has at least one fluid outlet above the rotor, as seen in the direction of gravity, in order to generate a primary coolant fluid flow.

4. The electric machine according to claim 3, wherein there is a fluid outlet hole on each end face of the rotor.

5. The electric machine according to claim 4, wherein the fluid outlet hole is dimensioned and arranged for substantially gravity-driven wetting of winding heads.

6. The electric machine according to claim 3, wherein at least two through holes are arranged on both sides of the longitudinal axis of the coolant fluid line.

7. The electric machine according to claim 6, wherein the through holes and fluid outlet holes have cross sections of the same size.

8. The electric machine according to claim 1, wherein the coolant fluid line is connected to a feed line.

9. A drive train of a motor vehicle, comprising an electric machine according to claim 1.

10. A method for cooling an electric machine, wherein oil from a coolant fluid line is both dripped under gravity onto a rotor and flows onto a stator winding.
